(19) United States
(12) Patent Application Publication
(10) Pub. No.: US 2010/0327729 A1
(43) Pub. Date: Dec. 30, 2010

(54) INFRARED HALOGEN LAMP WITH IMPROVED EFFICIENCY

(75) Inventors: Abbas Lamouri, Aurora, OH (US); Frederic Ahlgren, Highland Hts, OH (US); Juris Sulcs, Chagrin Falls, OH (US)

Correspondence Address: DUANE MORRIS LLP - DC, 505 9th Street, Suite 1000, WASHINGTON, DC, 20004-2166, US

(73) Assignee: Advanced Lighting Technologies, Inc., Solon, OH (US)

(21) Appl. No.: 12/825,167

(22) Filed: Jun. 28, 2010

Related U.S. Application Data
(60) Provisional application No. 61/220,872, filed on Jun. 26, 2009.

(51) Int. Cl. H01J 61/35; H01J 9/02; H01J 61/30; H01J 61/36

(52) U.S. Cl. 313/113; 445/29; 313/634; 313/624

(57) ABSTRACT

Methods for improving the efficiency of infrared (IR) halogen lamps and IR halogen lamps having improved efficiency are disclosed. In a method of aligning a filament in a lamp body, the lamp body having the filament therein is rotated, and tubular end portions are heated and necked down which may assist in positioning the filament within the lamp and reduce end losses. IR halogen lamps formed from glass tubes having an OD less than 5 mm are also disclosed. The reduced diameter of the glass tubing increases the surface area for IR energy reflection and reduces end losses. Spuds or beads may be used to position the filament within the lamp.

### CLAIM OF PRIORITY

This application claims the priority of U.S. Provisional Patent Application No. 61/220,872 filed Jun. 26, 2009, the content of which is incorporated herein in its entirety by reference.

### FIELD

The present subject matter pertains generally to infrared (IR) halogen lamps and more particularly to methods and apparatuses for increasing the efficiency of IR halogen lamps.

### BACKGROUND

Double ended infrared (IR) halogen lamps generally comprise a quartz tube, a tungsten filament, and a fill gas comprising an inert gas such as xenon and at least one halogen gas. Such lamps require a well defined shaped bulb and a precisely aligned filament in order to achieve maximum efficiency of infrared energy collection. FIGS. 1A-B depict a known halogen lamp 107. Referring to FIG. 1A, a lamp body 102 is formed from a quartz tube 104 having an inside (inner) diameter ID and an outside (outer) diameter OD. A light emitting chamber 106 (bulb) is formed using techniques known to one of ordinary skill in the art. A chamber 106 has an exterior coating (not shown). As shown in FIG. 1B, a filament 110, which may be a tungsten filament, is positioned within the lamp body 102, with a coiled portion positioned within the chamber 106. Spuds 112a-b align the filament 110 on a longitudinal axis of the lamp body. FIG. 1B shows sealed portions 114a-b that result from sealing the end portions 108a-b after positioning the filament 110 within the lamp body.

The outer surface of the chamber 106 is coated with a multilayer film (not shown) that transmits visible radiation (visible light) and reflects IR radiation back to the filament 110. Such a film is described in, e.g., U.S. Pat. No. 6,476,556, by Cottaar. The reflected IR energy is reabsorbed by filament 110 to decrease the power required to operate the lamp 107 without reducing the visible radiation output, thus improving efficiency. The amount of reabsorbed IR energy is highly dependent on the radial alignment of the filament 110 along the longitudinal axis of the lamp 107. Reflected energy that misses the filament 110 and is not reabsorbed eventually leaks through the end portions 114a-b. Such end losses do not contribute to the conversion of IR energy to visible radiation.

### SUMMARY

A method of aligning a filament in an electric lamp body includes providing a lamp body of light transmissive material. The lamp body includes a light emitting chamber intermediate first and second tubular end portions. A filament assembly having a refractory metal wire is provided. The filament assembly is positioned in the lamp body so that the wire extends from the light emitting chamber into each tubular end portion. The lamp body is rotated about its longitudinal axis. A portion of the first tubular end portion is heated and necked down so that the inside and outside diameter of the first tubular end portion is reduced as desired. The diameter of the end portion may be reduced sufficiently to assist in maintaining the position of the filament wire along the longitudinal axis of the lamp body. A portion of the second tubular end portion is heated and necked down so that the inside and outside diameter of the second tubular end portion is reduced as desired. The diameter of the end portion may be reduced sufficiently to assist in maintaining the position of the filament wire along the longitudinal axis of the lamp body.

A method of making an infrared (IR) halogen lamp includes providing a lamp body of light transmissive material. The lamp body includes a light emitting chamber intermediate first and second tubular end portions. The light emitting chamber is coated with an IR reflective coating. A filament assembly having a refractory metal wire is provided. The filament assembly is positioned in the lamp body so that the wire extends from the light emitting chamber into each tubular end portion. The lamp body is rotated about its longitudinal axis. A portion of the first tubular end portion is heated and necked down so that the inside and outside diameter of the first tubular end portion is reduced as desired. The diameter of the end portion may be reduced sufficiently to assist in maintaining the position of the filament wire along the longitudinal axis of the lamp body. A portion of the second tubular end portion is heated and necked down so that the inside and outside diameter of the second tubular end portion is reduced as desired. The diameter of the end portion may be reduced sufficiently to assist in maintaining the position of the filament wire along the longitudinal axis of the lamp body. The end portions are sealed and trimmed to a specified length. The light emitting chamber may be coated before or after the end portions are sealed and/or trimmed.

A double ended infrared (IR) halogen lamp includes a lamp body and a filament assembly. The lamp body includes a light emitting chamber intermediate sealed end portions. The filament assembly includes a mid portion positioned in the chamber and extending axially through each end portion. The lamp body proximate the each axial end of the chamber is necked down to reduce the inside and outside diameter of the lamp body in the necked down portions.

A double ended infrared (IR) halogen lamp includes a lamp body and a filament assembly positioned in the lamp body. The lamp body includes a light emitting chamber intermediate sealed tubular end portions that have an outside diameter of 4 mm or less and an inside diameter of 2 mm or less.

A double ended infrared (IR) halogen lamp includes a lamp body and a filament assembly. The lamp body has a light emitting chamber intermediate sealed tubular end portions. The filament assembly includes a mid portion and a pair of beads. The mid portion is positioned in the chamber and extending axially through each end portion. Each bead ensheaths a corresponding axial extension in an end portion of the lamp body.

### BRIEF DESCRIPTION OF THE DRAWINGS

The following will be apparent from elements of the figures, which are provided for illustrative purposes and are not necessarily to scale.

FIGS. 1A-B depict a known halogen lamp.

FIGS. 2A-F illustrate components of a double ended infrared (IR) halogen lamp at various stages of processing in accordance with some embodiments.

FIGS. 3A-E show components of a double ended IR halogen lamp at various stages of processing in accordance with some embodiments utilizing spuds.

FIGS. 4A-E show components of a double ended IR halogen lamp at various stages of processing in accordance with some embodiments utilizing beads.

FIG. 5 is an illustration of a lamp made in accordance with some embodiments employing necking down.

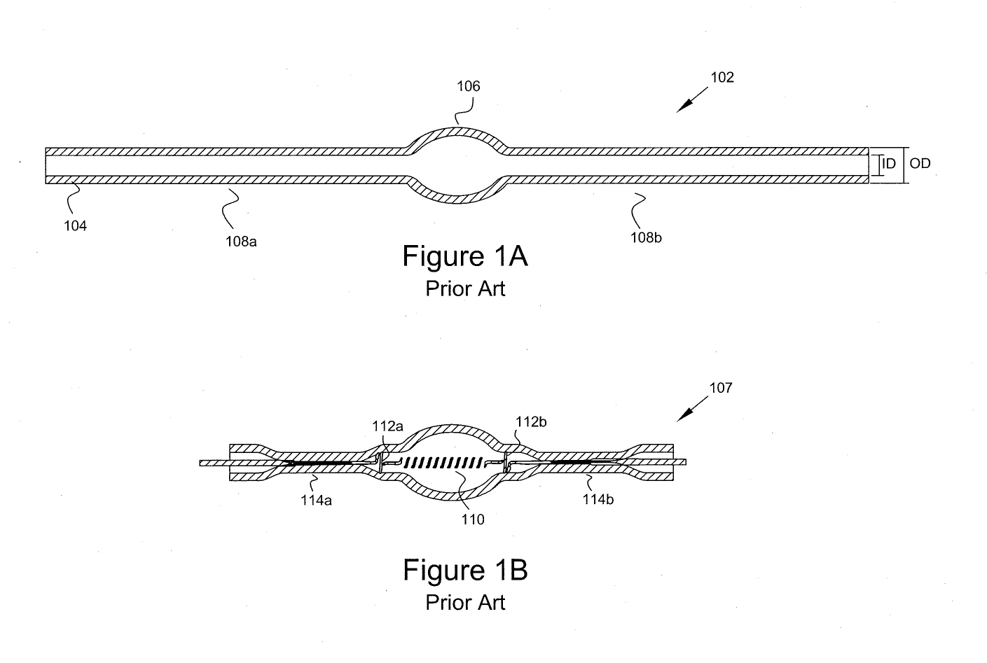

### DETAILED DESCRIPTION

Various embodiments improve upon prior art techniques by reducing end losses and/or increasing IR reflective surface area of halogen lamps, thereby increasing overall lamp efficiency.

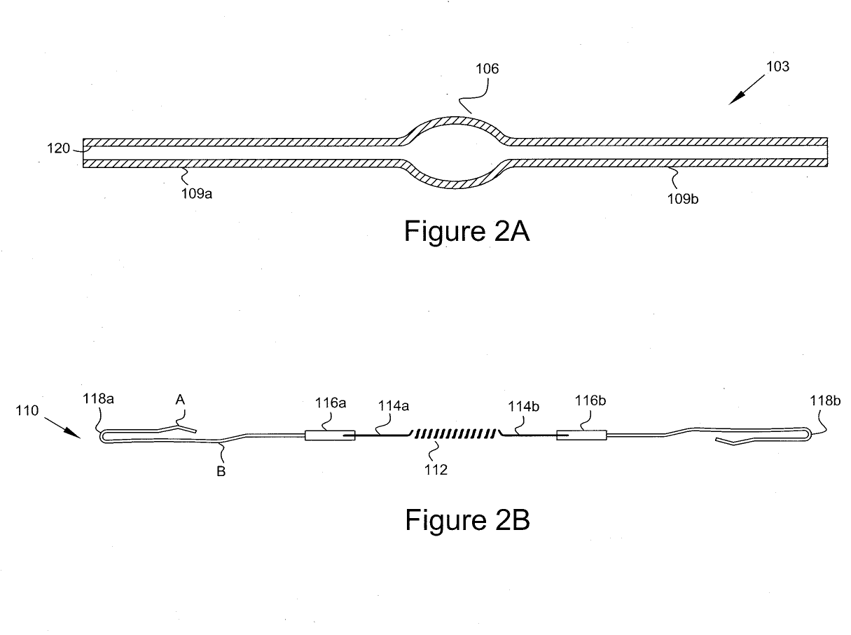

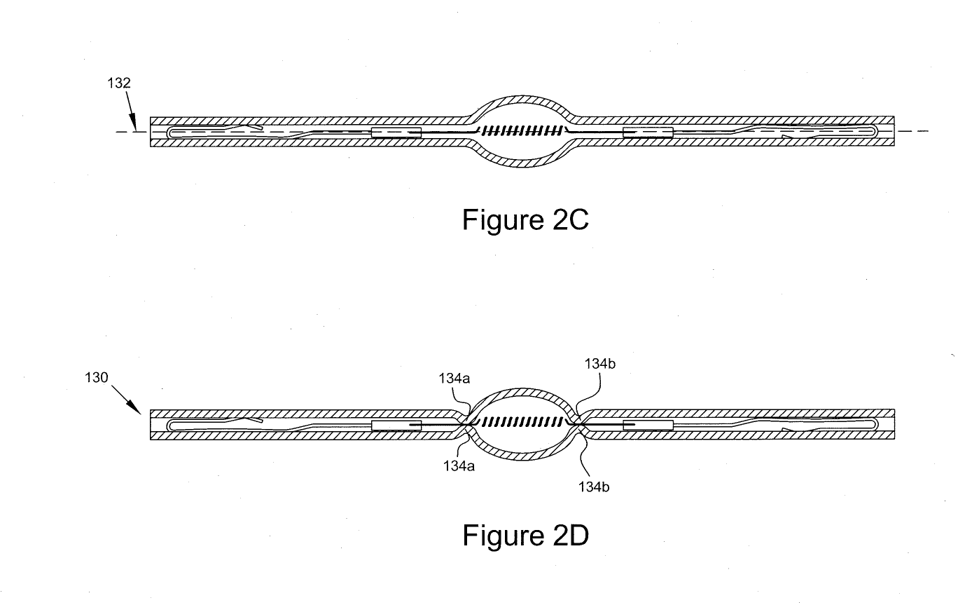

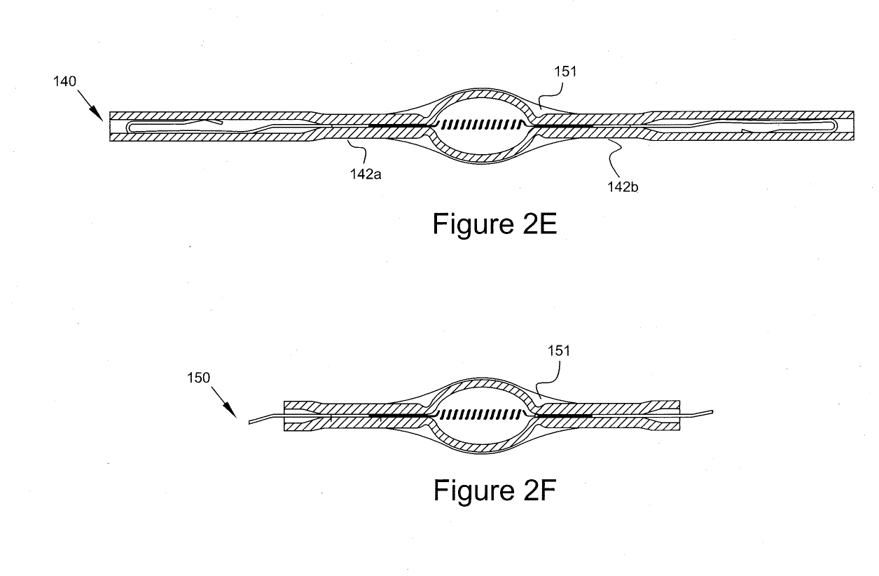

FIGS. 2A-2F illustrate components of a double ended infrared (IR) halogen lamp at various stages of processing in accordance with some embodiments. FIG. 2A shows a lamp body 103 having a light emitting chamber 106 intermediate (between) tubular end portions 109a-b (collectively 109). The chamber 106 may be bulbous, and in some embodiments, the chamber 106 is ellipsoidal or spherical. An outer surface of the chamber 106 may be coated with a coating 151 that reflects IR radiation and transmits visible light. The coating 151 may be a multilayer film that transmits visible radiation (visible light) and reflects IR radiation. Such a film is described in, e.g., U.S. Pat. No. 6,476,556, by Cottaar. The reflected IR energy is reabsorbed by a wire within the chamber, described below, to decrease the power required for lamp operation without reducing the visible radiation output. In some embodiments, the coating 151 is applied to the outer surface of the chamber 106 and extends beyond the necked down portions 134a-b. The coating 151 may be applied to the lamp body 103 prior to forming the bulb. Alternatively, the coating 151 may be applied to the lamp body after the bulb is formed.

FIG. 2B is an illustration of a filament assembly 110 having a refractory metal wire (filament) 112, which may be a filament made of tungsten. The wire 112 may be coiled, e.g., in a double coiled configuration, at a coiled portion and uncoiled at inlead portions 114a-b (collectively 114) as shown in FIG. 2. The coiled portion is a mid (central) portion of the filament assembly 110. Respective distal ends of the uncoiled inlead portions 112 are attached to foils 116a-b (collectively 116), which may be molybdenum foils. The filament assembly 110 may have bend portions 118a-b (collectively 118) that are attached to respective distal ends of the foils 116 and that form respective distal ends of the assembly. Bend portions 118 are dimensioned to frictionally engage an inner wall 120 of the end portions 109 of the lamp body 103 when the filament assembly 110 is positioned within the lamp body as described below in the context of FIG. 2C. Each bend portion 118 is dimensioned to contact the inner wall of a corresponding end portion 109 at two or more points. For example, the bend portion 118a is dimensioned to contact the inner wall 120 at least at points A and B. Each bend portion 118 lies in a single plane in some embodiments. For example, each bend portion 118 may be a reverse bend portion that has shape of a hairpin as in FIG. 2B, curving back towards the mid portion 112. In other embodiments (not shown), each bend portion does not lie in a single plane.

The filament assembly 110 is positioned within the lamp body 103 so that the wire 112 extends from the chamber 106 into each tubular end portion 109. Thus, the mid portion 112, which is a coiled portion in the example of FIGS. 2A-F, is positioned in the chamber 106 and extends axially through each end portion 109. The bend portions 118 frictionally engage the inner wall 120 of the end portions 109 to longitudinally fix the position of the filament assembly 110 within the lamp body 103. In some embodiments, the lamp body 103 having the filament assembly 110 positioned therein as in shown FIG. 2C is “necked down” (necked) to produce a collared assembly 130 as shown in FIG. 2D. In one embodiment, the lamp body 103 is necked down at the desired portions by rotating it about its longitudinal axis 132. A portion 134a of one of the end portions 109, e.g., end portion 109a, at an axial end of the chamber 106 (i.e., an end of the chamber along the longitudinal axis) is heated. The heated portion 134a is necked down using a disc (not shown) having a rotational axis parallel to the longitudinal axis 132 of the lamp body 103 which may move along a radius of the lamp body. The peripheral edge of the disc is contacted with the outer surface of the end portion 109a and moved inward along a radius of the end portion toward the longitudinal axis 132, thereby reducing the inside and outside diameters of the end portion 109a at the desired location. The disc may be controlled by a stepper motor, as is known to one of ordinary skill in the art. The heated portion 134a may be necked down sufficiently to assist in maintaining the position of the filament wire along the longitudinal axis 132 of the lamp body.

A portion 134b of the other end portion 109b is heated, and the heated portion 134b is necked down as described above regarding necked down portion 134a. The heated portion 134b may be necked down sufficiently to assist in maintaining the position of the filament wire along the longitudinal axis 132 of the lamp body.

In some embodiments, while the collared assembly 130 is still spinning, one of the end portions, e.g., end portion 109a, is hermetically sealed, e.g., by shrink sealing the end portion on the lathe as is known to one of ordinary skill in the art. The other end portion 109b may be sealed in a like manner. Thus, a collared burner 140 with sealed end portions 142a-b is produced as shown in FIG. 2E.

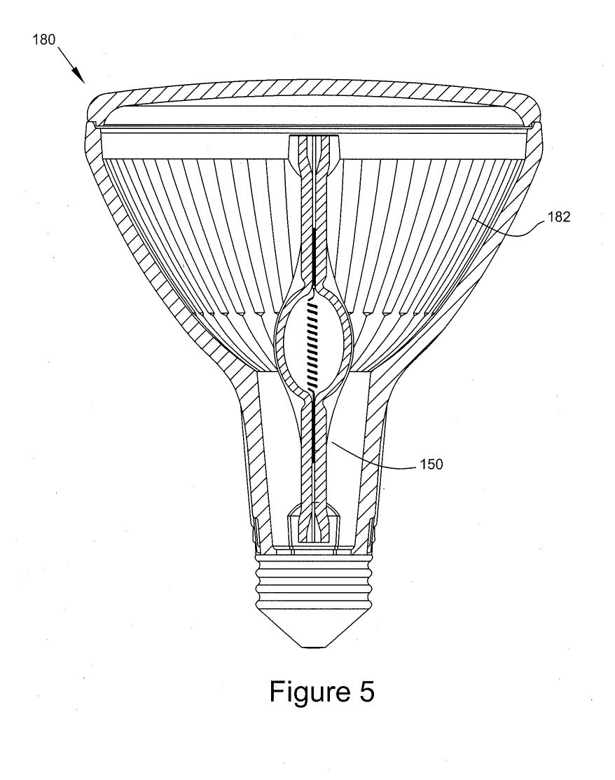

As shown in FIG. 2F, the collared burner 140 is trimmed at both ends to produce a trimmed burner 150. The trimmed burner 150 is ready for finishing, e.g., for installation in a housing as shown in FIG. 5.

Necking down the end portions according to some embodiments centers the filament assembly 110 in the chamber 106, i.e., ensures that the mid portion 112 of the wire is positioned along the longitudinal axis 132. Necking down the lamp body also advantageously increases efficiency by allowing more IR radiation to be reflected back to the filament 112 than with prior art IR halogen lamps. Such an efficiency gain is enabled because, as shown in FIG. 2D, necking down the lamp body reduces the diameter of the lamp body 103 at the necked down portions 134a-b, thereby increasing the surface area of chamber 106 available for IR reflection. Furthermore, necking down the lamp body reduces end losses to increase efficiency further, because respective conduits from the interior of the chamber 106 into respective interiors of the tubular end portions 109 are narrowed at the necked down portions 134a-b.

In some embodiments, each end portion 109 includes an inner diameter less than 4 mm. The outer diameter of each end portion 109 may be less than 5 mm. In some embodiments, the inner and outer diameters of the end portions 109 may be 2 mm or less and 4 mm or less, respectively. It had been discovered that by forming the lamp body from tubes having reduced diameters (inner and outer diameters) relative to typical 5 mm OD tubes used in the prior art increases efficiency by lowering end losses and increasing the surface area of the IR coating 151 on the chamber 106.

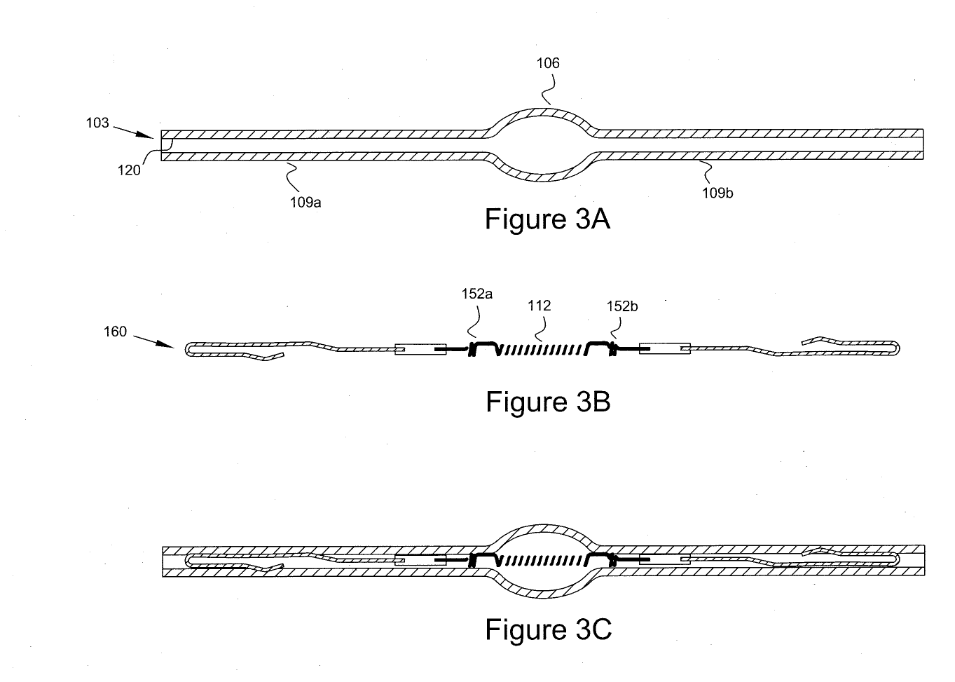

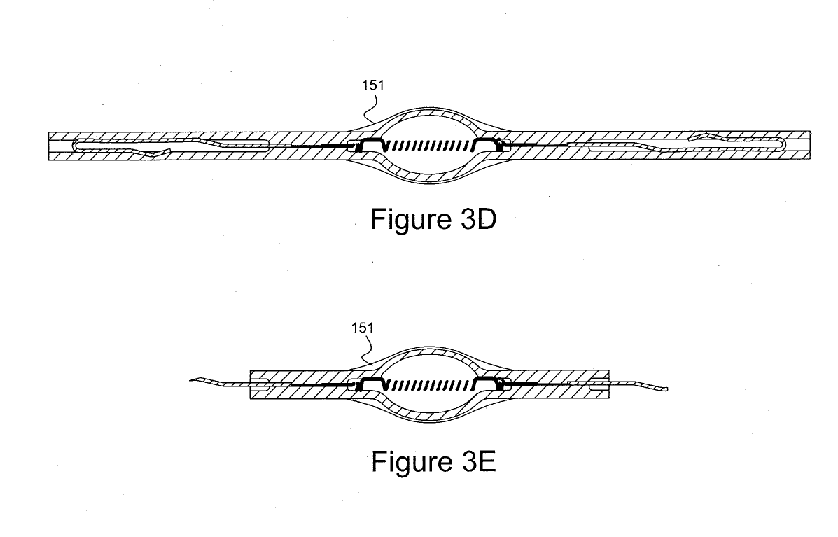

FIGS. 3A-E show components of a double ended IR halogen lamp at various stages of processing in accordance with some embodiments utilizing spuds to assist in positioning the filament. FIG. 3A is an illustration of a lamp body 103 having a chamber 106 and the end portions 109. As shown in FIG. 3B, the filament assembly 160 includes a mid portion 112 of a filament, which may be a coiled portion, and spuds 152a-b (collectively 152). The mid portion 112 is positioned in the chamber 106, as shown in FIG. 3C, and extends axially through each end portion 109. Each spud 152 has the shape of a ring having an outside diameter equal to the inside diameter of a corresponding end portion 109 of the lamp body 103 so that spuds 152 contact the inner wall 120 of the end portions. Thus, when the filament assembly 160 is positioned within the lamp body 103, the spuds 152 support respective end portions 109. Thus, the spuds 152 assist in positioning the filament in the chamber 106 along the longitudinal axis of the lamp body 103. The spuds 152 according to one embodiment are smaller (have a smaller ring diameter) than the prior art spuds which leads to increased efficiency by enabling increased surface area of the IR coating 151 of chamber 106.

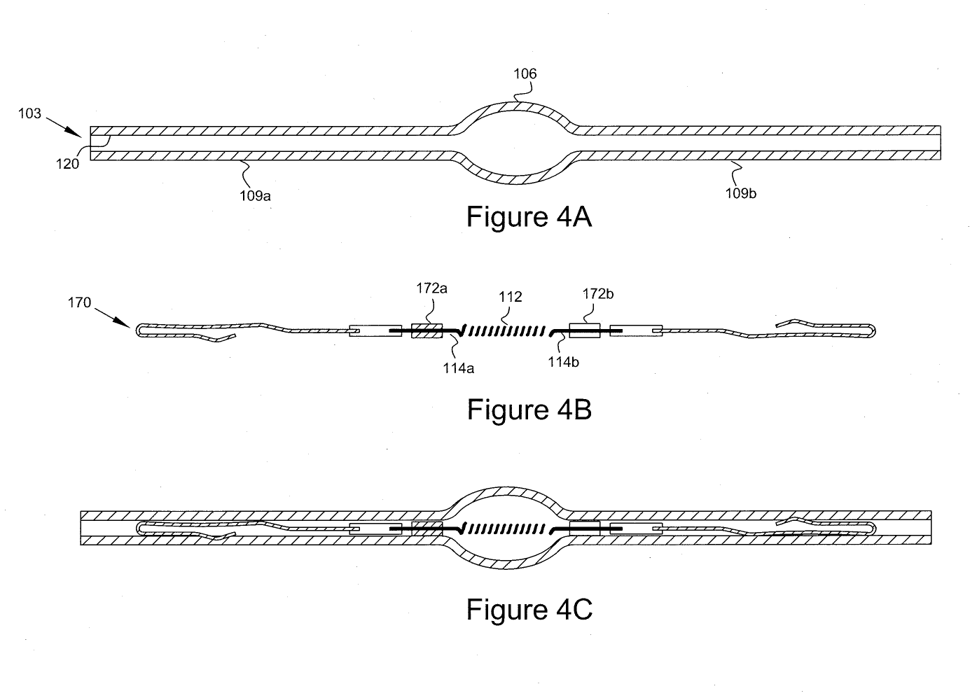

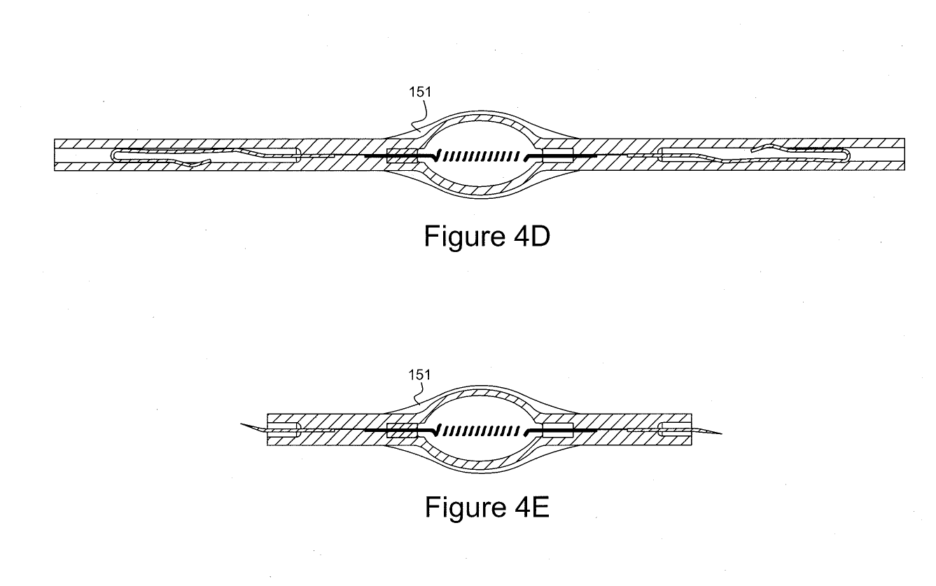

FIGS. 4A-E show components of a double ended IR halogen lamp at various stages of processing in accordance with some embodiments utilizing beads to assist in positioning the filament. FIG. 4A is an illustration of a lamp body 103 having a chamber 106 and end portions 109. As shown in FIG. 4B, the filament assembly 170 includes a mid portion 112 of a filament, which may be a coiled portion, and beads 172a-b (collectively 172). The mid portion 112 is positioned in the chamber 106, as shown in FIG. 4C, and extends axially through each end portion 109. The beads may have any suitable shape such as spherical or cylindrical. According to the illustrated embodiment, each of the beads 172 may be a cylindrical bead of a vitreous, light transmissive material, e.g., glass or quartz. Each of the beads 172 defines a central opening through which a corresponding uncoiled inlead portion of the filament assembly is passed. The beads 172 are dimensioned to contact the inner wall 120 of a corresponding end portion 109 to assist in positioning the filament in the chamber 106 along the longitudinal axis of lamp body 109.

FIG. 5 is an illustration of a lamp made in accordance with some embodiments employing necking down, e.g., as in FIG. 2F. The lamp 180 includes a trimmed burner 150 in a parabolic aluminized reflector (PAR) housing 182. Such a housing is known to one of ordinary skill in the art. The lamp 180 may be a 12 V lamp having a PAR30 sizing, i.e., a 3.75 inch diameter; other sizes and voltages may be used as well.

Although examples are illustrated and described herein, embodiments are nevertheless not limited to the details shown, since various modifications and structural changes may be made therein by those of ordinary skill within the scope and range of equivalents of the claims.

What is claimed is:

1. A method of aligning a filament in an electric lamp body, the method comprising:
providing a lamp body of light transmissive material, the lamp body including a light emitting chamber intermediate first and second tubular end portions;
providing a filament assembly comprising a refractory metal wire;
positioning the filament assembly in the lamp body so that the wire extends from the light emitting chamber into each tubular end portion;
rotating the lamp body about its longitudinal axis;
heating a portion of the first tubular end portion;
necking down the heated portion of the first tubular end portion;
heating a portion of the second tubular end portion; and
necking down the heated portion of the second tubular end portion.

2. The method of claim 1 wherein the step of necking down the heated portion of the first or second tubular end portion comprises contacting a disc having a rotational axis parallel to the rotational axis of the lamp body with the outer surface of the end portion and moving the disc along a radius of the end portion toward the longitudinal axis of the lamp body to thereby reduce the diameter of the end portion at a desired location.

3. The method of claim 1 wherein the light emitting chamber is bulbous and the end portions are necked down adjacent the light emitting chamber.

4. The method of claim 3 wherein the light emitting chamber is ellipsoidal.

5. The method of claim 3 wherein the light emitting chamber is spherical.

6. The method of claim 1 wherein the filament assembly comprises refractory metal wire having a central coiled portion and uncoiled inlead portions extending axially from each end of the coiled portion, wherein the coiled portion is positioned in the light emitting chamber of the lamp body and each uncoiled inlead portion extends into one of the tubular end portions of the lamp body.

7. The method of claim 6 wherein the tubular end portions are necked down sufficiently to maintain the position of the respective uncoiled inlead portions of the filament assembly positioned therein along the longitudinal axis of the lamp body.

8. The method of claim 1 wherein the filament assembly includes bend portions forming each distal end of the assembly, the bend portions being dimensioned to frictionally engage the inner wall of the end portions of the lamp body to thereby longitudinally fix the position of the filament assembly within the lamp body.

9. The method of claim 8 wherein the bend portions are reverse bend portions that bend towards a mid portion of the assembly.

10. The method of claim 1 wherein the end portions have an outside diameter of 5 mm or less.

11. The method of claim 10 wherein the end portions have an outside diameter of 4 mm or less.

12. A method of making an infrared (IR) halogen lamp, the method comprising:
providing a lamp body of light transmissive material, the lamp body including a light emitting chamber intermediate first and second tubular end portions;
coating the light emitting chamber with an IR reflective coating;
providing a filament assembly comprising a refractory metal wire;
positioning the filament assembly in the lamp body so that the wire extends from the light emitting chamber into each tubular end portion;
rotating the lamp body about its longitudinal axis;
heating a portion of the first tubular end portion;
necking down the heated portion of the first tubular end portion;
heating a portion of the second tubular end portion;
necking down the heated portion of the second tubular end portion;
sealing the end portions; and
trimming the end portions to a specified length.

13. The method of claim 12 wherein the step of sealing the end portions comprises shrink sealing the end portions.

14. The method of claim 12 wherein the end portions have an outside diameter of 5 mm or less.

15. The method of claim 12 wherein the end portions have an outside diameter of 4 mm or less.

16. The method of claim 12 wherein the step of coating the light emitting chamber with an IR reflective coating is performed prior to the step of sealing the end portions.

17. The method of claim 12 wherein the step of coating the light emitting chamber with an IR reflective coating is performed after the step of sealing the end portions.

18. A double ended infrared (IR) halogen lamp comprising:
a lamp body having a light emitting chamber intermediate sealed end portions; and
a filament assembly having a mid portion positioned in said chamber and extending axially through each of said end portions;
wherein said lamp body includes necked down portions proximate each axial end of said chamber.

19. The lamp of claim 18 further comprising an IR reflective coating on an outer surface of the lamp body forming said light emitting chamber.

20. The lamp of claim 19 wherein said IR reflective coating covers the outer surface of the lamp body in an area extending from the longitudinal center of the lamp body beyond each necked down portion of said body.

21. The lamp of claim 18 wherein said light emitting chamber is ellipsoidal or spherical.

22. The lamp of claim 18 wherein the end portions comprise tubular portions having an outside diameter of 5 mm or less.

23. The lamp of claim 22 wherein the end portions comprise tubular portions having an outside diameter of 4 mm or less.

24. A double ended infrared (IR) halogen lamp comprising:
a lamp body having a light emitting chamber intermediate sealed tubular end portions, the end portions having an outside diameter of 4 mm or less and an inside diameter of 2 mm or less; and
a filament assembly positioned in the lamp body.

25. The lamp of claim 24 wherein said filament assembly comprises a pair of spuds having a diameter of 2 mm or less.

26. A double ended infrared (IR) halogen lamp comprising:
a lamp body having a light emitting chamber intermediate sealed tubular end portions; and
a filament assembly including:
a refractory metal wire positioned in said chamber and extending axially through each of said end portions; and
a pair of beads, each bead ensheathing a portion of said wire extending in an end portion of said lamp body.

27. The lamp of claim 26 wherein said beads are cylindrical or spherical.

28. The lamp of claim 27 wherein said beads have a diameter of 2 mm or less.

29. The lamp of claim 26 wherein said beads are formed from glass or quartz.
